(19) United States
(12) Patent Application Publication
(10) Pub. No.: US 2025/0008877 A1
(43) Pub. Date: Jan. 9, 2025

(54) BERRY HARVESTER FILLING SYSTEM

(71) Applicant: Ploeger Oxbo Holding B.V., Roosendaal (NL)

(72) Inventors: Thomas Simon Kok, Blaine, WA (US); Kevin Michael Roberts, Custer, WA (US)

(21) Appl. No.: 18/764,823

(22) Filed: Jul. 5, 2024

Related U.S. Application Data
(60) Provisional application No. 63/512,220, filed on Jul. 6, 2023.

(51) Int. Cl. A01D 61/04; A01D 46/22

(52) U.S. Cl. CPC A01D 61/04; A01D 46/22

(57) ABSTRACT

A fruit harvester includes a chassis, a fruit removal system, a fruit delivery system, and a container delivery system for automatically delivering individual containers. A container filling station receives fruit from the fruit delivery system and fills individual containers. The container delivery system automatically separates a bottommost container from a stack of the containers. The container delivery system includes a support framework defining a vertical open shaft configured for supporting a stack of containers. An elevator carriage moves vertically below the stack of containers. Retractable clamps engage edges of the containers in an extended position.

### BACKGROUND OF THE INVENTION

### Field of the Invention

The present invention relates to a berry harvester and filling system for automatically managing containers and consistently filling the containers with fruit.

### Description of the Prior Art

The present invention relates to a berry harvester and container filling system that connects to a fruit conveying system and weighs containers to ensure consistent filling levels. Berry harvesters are used to mechanically harvest fruit from plants. Such harvesters typically include beaters or other elements that dislodge the fruit from the plants and a conveyor system to deliver the fruit. The harvester may also include fans or other devices to aid in discharging undesirable materials such as leaves, sticks and other debris from the fruit. Berry harvesters typically deliver the fruit to a filling station, and sometime an inspection station, on a conveyor that delivers the berries to containers, widely referred to as lugs or flats, depending on the configuration of the containers. The flats hold approximately 3-15 pounds while lugs have a capacity of about 15-25 pounds. Conventional harvesters deliver the fruit, while workers known as operators, sorters or stackers manually place and handle the flats or lugs for filling. The stackers remove the flats or lugs when they estimate that a predetermined amount of fruit has been delivered to the container. In addition, typically a second container is placed below the first container so that fruit may be recovered while the upper containers are being switched.

Although such a system provides for recovering the harvested berries, the reliance on a worker to judge when a desired amount of fruit has been delivered has drawbacks. Such a system requires a paid employee to spend considerable time watching berries fall into lugs. People willing to perform this job are becoming more difficult to find and more expensive to employ. Moreover, the amount of berries in a “full” lug can vary greatly. It has been found that the variability depends upon the experience and skill of the workers and that changing of tasks during a shift on the harvester may increase or decrease in the perceived amount of fruit being collected in each container. Moreover, as workers tire during a long shift, variability may increase or decrease. Such workers also need to manage the containers and any problems may affect the filling process. The variance in the weight of the fruit collected in each container has consequences at the processing plants where the fruit is often delivered from flats automatically to be cleaned, and/or in some cases, frozen or pureed. Efficiency at such plants is tied to the volume of fruit being processed and the selected operating level should be sufficient to cover the upper limit of fruit delivered. If the volume of fruit varies from container to container, the processing plant must be operated slowly enough to accommodate the highest volume of fruit. However, if there is less variability, the plant may be able to operate at a higher level without exceeding its capacity limit. Throughput is increased and higher efficiencies are achieved.

To address these issues, a weighing system has been developed to fill the containers more accurately and consistently with a predetermined amount of fruit. Such a weighing system is disclosed in U.S. Pat. No. 10,834,873 to Korthuis, entitled BERRY HARVESTER WEIGHING SYSTEM. This system utilizes a weighing system that also cancels out vibrations for greater accuracy to achieve containers filled with a consistent amount of fruit.

Although the system of the Korthuis '873 patent improved the consistency of filled containers, issues may still arise due to the manual management of the containers. Workers are required to move a supply of empty containers and manually provide an empty container to the filling station. While the stackers are alerted when the container is filled to the desired amount of fruit, the stacker may be delayed in reacting and may not always switch the container out when alerted by the alarm. Moreover, the manual handling of containers requires additional labor and space on the deck of the harvester.

It can therefore be seen that an automatic container handling system for a fruit harvester is needed. Such a container handling system should provide for automatically removing a container from a stack of containers, delivering the container to a filling station, conveying fruit into the container until filled with a desired amount of fruit, and moving the filled container out of the filling station. Such a system should provide for decreasing the labor needed and cost of operating a harvester. The present invention addresses these as well as other problems associated with berry harvesters and the filling and handling of containers.

### SUMMARY OF THE INVENTION

The present invention is directed to a fruit harvester, typically a berry harvester, and a container management system. An over the row berry harvester includes a chassis driving on wheels. A picking assembly engages rows of plants that pass through a picking tunnel. The picking assembly generally includes beaters, which may take on many configurations, or other plant engagement devices that dislodge fruit from the plants. A fruit catching system includes movable catch plates that collect the dislodged fruit, which rolls to a conveyor system. The conveyor system dumps the collected fruit onto a container filling and weighing system. A cleaning system includes fans and may also include a manual inspection station at the container filling system to remove unwanted leaves, dirt and debris other than the fruit.

An operator sits in a driver's seat to access the harvester controls. Workers inspect fruit and manage filled containers on an operations platform. In some embodiments, sorter seats provide a place for inspecting fruit before being put into containers. Processor/controls are accessed by at least one of the sorters or stackers to operate the filling and weighing system. Railings provide safety while ladders provide access to the harvester for the operators.

Once filled, the containers are transported to the fruit processing plant. Containers are managed and filled with three main sub-systems. A first sub-system is a container filling and weighing station with a device for sensing the amount of berries in the container currently under the fruit stream of the filling and weighing station. A second sub-system is a container transport assembly that conveys containers removed from the container stack to and through the fruit stream. A third sub-system is a container unstacking assembly that unstacks empty berry containers from a container stack. The container unstacking assembly and the container transport assembly may be coupled together to form a container supply system.

The container filling and weighing station, container unstacking assembly, and the container transport assembly are in communication with the processor that coordinates their operation and allows operator input for start/stop, calibration, and other functions. Together the systems of the present invention eliminate several tedious manual operations and allow a farmer to standardize the weight of full berry containers across their entire operation.

The container fill and weighing station includes load cells engaging a weighing deck located underneath the discharge point of the fruit conveyor. The load cells are actuated by the containers being placed on the weighing deck. The processor/controls provide for taking the weight of the container into account and using a tare equal to the container weight. It can be appreciated that the fill and weighing system is automatically set to weigh the crop in a container. The controls include a display of various parameters including the weight of the fruit in the currently filling container, total weight harvested and the target weight of each full container. The harvester may include a global positioning system, such as a DataStar Crop Analyst system, to track and map crop data. The processor/controls also incorporate an isolation system that eliminates vibrations from machinery and therefore ensures that there are no false readings and the actual weight of the berries in a container is accurate. The system utilizes the load cells in order to ensure that the weighing system automatically resets when a filled container is removed from the weighing deck.

The container supply system includes the container unstacking assembly and the container transport assembly. The container unstacking assembly includes a base and a housing. A tower is formed by the housing and extends vertically from the base. The tower defines a vertical shaft in which a stack of individual containers is retained.

According to the present invention, empty containers are delivered to the filling weighing station by the container transport assembly, starting with an empty container positioned under the fruit stream coming off the conveyor. Once the container has reached the target level, the container transport assembly automatically moves the full container out of the fruit stream onto a discharge table, belt, or other part of the harvester. The container transport assembly also moves an empty container under the fruit stream.

Containers are moved together, such as by an electric motor driving a belt or chain. In one embodiment, containers are moved by a continuous belt with regularly spaced flights. The flights are set apart on the belt to maintain proper spacing of the containers. In another embodiment, container are moved by a chain with paddles attached. The paddles are pulled by the chain and are spaced apart so that each paddle pushes one container. The container transport assembly with the flights or paddles spaced apart maintains containers at the proper spacing. Spacing of the flights or paddles may be tailored to accommodate a particular style or size container. The operation of the container unstacking assembly and the container transport assembly is coordinated and automatically controlled by the processor receiving information from the filling and weighing system. Therefore, containers are automatically delivered for filling, then accurately filled while being weighed until receiving the desired amount of fruit, and then delivered as full containers to an easily accessed position for delivery to a processing plant.

Once a container is filled to the prescribed amount of fruit, the container transport assembly automatically advances all containers so that an empty container is moved into the filling position. When a new empty container has been moved under the fruit stream, the container unstacking assembly automatically removes another empty container from the bottom of the stack of containers and positions the container before a paddle. The present invention may include automatic positioning conducted with other configurations, such as by removing a container from the top of the stack, feeding an empty container off a conveyor, or placing a container using a robotic arm, for reliability and a compact layout.

The container unstacking assembly generally includes a base, and a housing forming a tower structure creating a rectangular vertical shaft receiving the container stack. The tower is loaded with a stack of empty containers from the top, either manually or automatically using an additional automated mechanism. The container unstacking assembly is operated by two actuators. The first actuator moves a pair of supports, which together form an elevator carriage that moves vertically within the tower. The second actuator operates a clamp to hold a stack of empty containers within the tower.

The container unstacking assembly includes an elevator assembly including side supports extending below the container stack to form a carriage and support the bottommost container. The opposed side supports are joined by an exterior coupling arm so that the carriage half formed by one of the side supports moves with the opposed carriage half formed by the other side support in tandem to form the vertically movable carriage. The elevator assembly includes a lift assembly having a carriage drive and a guide mechanism to provide smooth up and down movement of the carriage within the vertical shaft formed by the tower.

The container unstacking assembly also includes an end engagement assembly configured to engage the ends of a container and support the container as well as any containers stacked above the supported container. In one embodiment, a clamp actuator is connected to a linkage with a cam rotationally supported on a corresponding shaft at each end of the tower. When the clamp actuator extends and retracts, the end support clamps, or tabs are extended and retracted together. When in an extended position, the end support tabs function as clamps to engage one of the containers below the upper lip of the container.

When in the extended position, the entire container stack above the end support tabs is supported on the end engagement assembly. When the clamp actuator is retracted, the end support tabs are pulled away from one another and are disengaged from any of the containers. The stack is then supported on the carriage. The actuator and cam mechanism is just one example of a clamping apparatus, which could also be operated in a variety of other ways to extend and retract end engagement members.

To remove a container from the stack, the container unstacking assembly proceeds through a series steps repeated for each container. In a first operational position, the carriage is completely lowered. A bottommost container has been separated and advanced by the container transport assembly. At this operational position, the end support tabs are extended toward one another, and the container stack is supported by the end engagement assembly.

To remove the bottommost container from the container stack, the elevator drive retracts, moving the carriage up and lifting the entire stack of empty containers off the end support tabs. Both halves of the carriage are raised simultaneously by using the connecting arm pivoting at the side of the tower. The connecting arm transfers the motion of the elevator actuator to the far side of the tower and keeps the carriage halves aligned on opposite sides of the container stack and moving together. The carriage is raised until engaging the bottommost container and the entire stack of containers is lifted in a second operational position.

From the second operational position, the end actuator rotates the cams, retracting the tabs on both ends of the stack of containers. The end actuator is connected to the linkage, which coordinates extension and retraction of the clamp halves formed by the end support tabs on each end of the tower. At this third operational position, the carriage is raised as in the second operational position, but the end support tabs are retracted.

The carriage is then moved down by an amount equal to the spacing of one container in the stack. At this fourth operational position, the carriage is raised, but at a position lower than at the second and third operational positions, and with the stack lowered so the bottommost container is below the end support tabs, which are still retracted.

While the carriage is at this height with only the bottommost container below the end support tabs, the end support tabs are extended and function as a clamp and support the stack of containers, except for the bottommost container, which is below the end support tabs. At this fifth operational position, the carriage is at the same height as in the fourth operational position, and the end support tabs are extended so that the next to bottommost container is supported on the end support tabs, while the bottommost container is separated from the stack and separately supported on the carriage.

The carriage then moves downward, and the bottommost container is lowered away from the rest of the stack. At this sixth operational position, the carriage supports the separated container at a fully lowered position and the remaining containers are supported on the end support tabs. At this operational position, the bottom container pulled from the stack has been positioned next to the container currently being filled (in the “on deck” position), and the entire process can be repeated.

In one embodiment, the carriage includes spring loaded tabs that slide past the edges of the containers while the carriage is moving upward, but cannot move past the edge of the containers while the carriage is moving downward. The tabs are configured with a sloped upper engagement surface and a substantially horizontal lower engagement surface. The tabs are rotatably mounted and biased by a spring. When moving upward the sloped upper engagement surface engages the underside of the lip of the containers and is pivoted outward, allowing the tab to move upward past the bottommost container. The spring pulls the tab back to a home position with the lower engagement surface of the underside of the tab being substantially horizontal. The lower engagement surface therefore engages the top of the lip of the bottommost container. The extended tab allows the downward motion of the carriage to pull the lowest container from the bottom of the stack. As the carriage moves downward, the separated container is taken down to the starting, lowest position. This spring loaded tab is just one example of an apparatus to remove the lowest container from the bottom of the stack during the downward motion of the carriage.

Prior to operation, variables may be input into the processor. The weight of the containers used may be stored as a tare, allowing only the weight of the fruit in the container to be measured. Moreover, the desired weight may be input so that the alarms will signal when the preselected weight is reached and to initiate automatic movement of containers. In some embodiments, the type of alarm and readouts may also be adjusted. When the weighing system has been set, the harvester may proceed with harvesting along plant rows with the fruit plants passing through the picking tunnel. The picking assembly engages the plants and dislodges fruit. The fruit falls onto the catching system where it is directed to the conveyor assembly. Material other than fruit is separated by the cleaning system. The conveyors deliver the fruit to the fill and weighing system where the fans provide final separation. Workers may also inspect the fruit to remove fruit that is not acceptable and/or other debris. The unstacking assembly and the container transport assembly automatically provide an empty container on the weighing deck. Fruit is delivered until the preselected amount of fruit is received into the container. The system may then provide an alarm and/or readout to the operators that the container is filled to the desired weight. The transport assembly then moves the filled container and slides a second empty container into the space for filling on the weighing deck. The filled container is stored on the deck until the end of the row is reached or a convenient point for unloading the filled containers is reached.

During the entire fruit loading process, the processor is able to filter out movement and vibration imparted from the over the row harvester and provide an accurate reading. Once the desired weight is achieved, the processor automatically resets the system for a new empty container. The process is repeated until the system is shut off. It can be appreciated that interruptions, including lengthy pauses do not affect the weighing system or the container delivery assembly. Moreover, if conditions or requirements change, the container filling system may be reset with different inputs to reflect the requirements.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings, wherein like reference letters and numerals indicate corresponding structure throughout the several views:

FIG. 1 is a perspective view of a berry harvester according to the principles of the present invention;

FIG. 2 is a side elevational view of the berry harvester shown in FIG. 1;

FIG. 3 is a front elevational view of the berry harvester shown in FIG. 1;

FIG. 4 is a perspective view of an embodiment of an inspection and container loading system for a berry harvester similar to the system shown in U.S. Pat. No. 10,834,873;

FIG. 5 is a side elevational view of the inspection and container loading system shown in FIG. 4;

FIG. 6 is a perspective view of a weighing system for the inspection and container loading system shown in FIG. 4 with containers shown in phantom;

FIG. 7 is a perspective view of a tray for the weighing system shown in FIG. 6;

FIG. 8 is a top plan view of the weighing system shown in FIG. 6;

FIG. 9 is a bottom perspective view of the weighing system shown in FIG. 6;

FIG. 10 is a perspective elevational view of an embodiment of an inspection and container loading system configured for use with an automatic container transport system for the harvester shown in FIG. 1;

FIG. 11 is a perspective view of a container handling system for the fruit harvester shown in FIG. 1;

FIG. 12 is a side elevational view of the container handling system shown in FIG. 11;

FIG. 13 is an end view of the container handling system shown in FIG. 11;

FIG. 14 is a top view of the container handling system shown in FIG. 11;

FIG. 15 is a perspective view of the container handling system shown in FIG. 11 with portions of the housing removed for clarity;

FIG. 16 is a side elevational view of the container handling system shown in FIG. 12 with portions of the housing removed for clarity;

FIG. 17 is an end view of the container handling system shown in FIG. 13 with portions of the housing removed for clarity;

FIG. 18 is a top view of the container handling system shown in FIG. 14 with portions of the housing removed for clarity;

FIG. 19 is a side elevational view of the container handling system shown in FIG. 16 without containers;

FIG. 20 is an end view of the container handling system shown in FIG. 17 without containers;

FIG. 21 is a perspective view of a first embodiment of a container transport assembly for the container handling system shown in FIG. 11;

FIG. 22 is a side view of a portion of the container transport assembly shown in FIG. 21;

FIG. 23 is a perspective view of the container transport assembly shown in FIG. 21 without containers;

FIG. 24 is a side view of a portion of the container transport assembly shown in FIG. 22 without containers;

FIG. 25 is a top view of the container transport assembly shown in FIG. 23;

FIG. 26 is a bottom view of the container transport assembly shown in FIG. 23;

FIG. 27 is a side sectional view of the container handling system shown in FIG. 16 in a first operational position without a separated container and with the carriage lowered and the tabs extended and supporting the stack of containers;

FIG. 28 is an end sectional view of the container handling system shown in FIG. 27 in the first operational position without a separated container and with the carriage lowered and the tabs extended and supporting the stack of containers;

FIG. 29 is a side sectional view of the container handling system shown in FIG. 16 in a second operational position with the carriage raised and the stack is lifted off of the retractable tabs;

FIG. 30 is an end sectional view of the container handling system shown in FIG. 16 in the second operational position with the carriage raised and the stack is lifted off of the retractable tabs;

FIG. 31 is a side sectional view of the container handling system shown in FIG. 16 in a third operational position with the carriage raised as in the second operational position and the tabs are retracted;

FIG. 32 is a side sectional view of the container handling system shown in FIG. 16 in a fourth operational position with the carriage raised, but at a position lower than the second and third operational positions, and the stack lowered so the bottommost container is below the retracted tabs;

FIG. 33 is an end sectional view of the container handling system shown in FIG. 16 in the fourth operational position with the carriage raised, but at a position lower than the second and third operational positions, the stack lowered so the bottommost container is below the retracted tabs;

FIG. 34 is a side sectional view of the container handling system shown in FIG. 16 in a fifth operational position with the carriage at the same height as in the fourth operational position, the tabs extended, and the next to bottommost container supported on the tabs, while the bottommost container is separated from the stack;

FIG. 35 is a side sectional view of the container handling system shown in FIG. 16 in a sixth operational position with the carriage supporting the separated container in a fully lowered position and the remaining containers supported on the tabs;

FIG. 36 is an end sectional view of the container handling system shown in FIG. 16 in the sixth operational position with the carriage supporting the separated container is in a fully lowered position and the remaining containers are supported on the tabs;

FIG. 37 is a side detail view of the spring loaded end tab for the carriage and a container prior to engagement and removal from the bottom of the container stack;

FIG. 38 is a side detail view of the spring loaded end tab for the carriage in an engagement position for removing the bottommost container from the container stack;

FIG. 39 is a diagrammatic view of sensing and display systems for the filling and weighing system and the container handling system for the harvester shown in FIG. 1;

FIG. 40 is a flow diagram for the container handling system;

FIG. 41 is a perspective view of a second embodiment of a container transport assembly without containers;

FIG. 42 is a top view of the container transport assembly shown in FIG. 41;

FIG. 43 is a top view of the container transport assembly shown in FIG. 41; and

FIG. 44 is a bottom view of the container transport assembly shown in FIG. 41.

### DETAILED DESCRIPTION OF THE PREFERRED EMBODIMENT

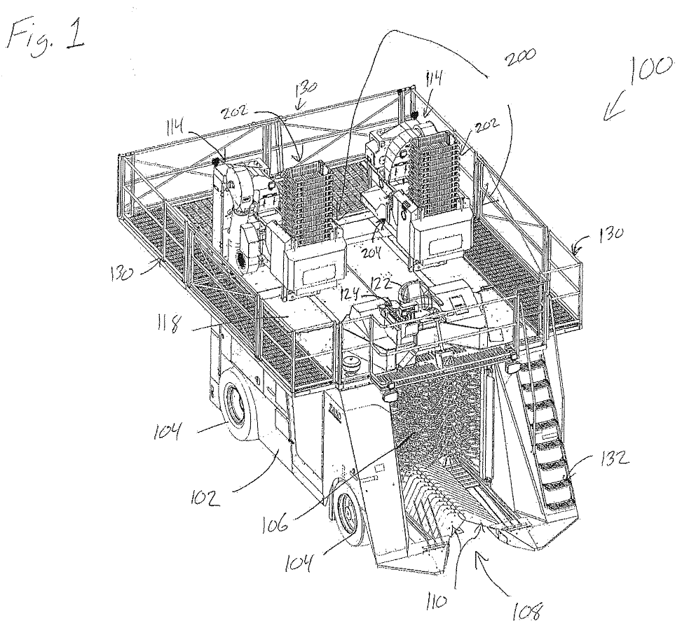

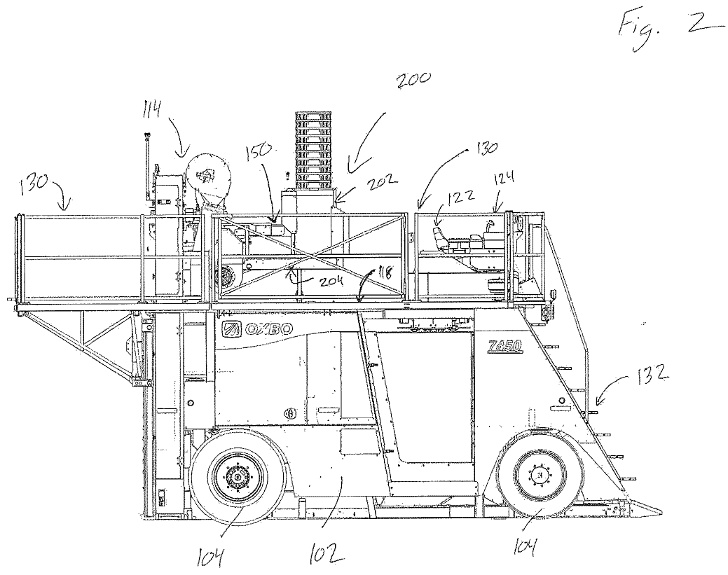

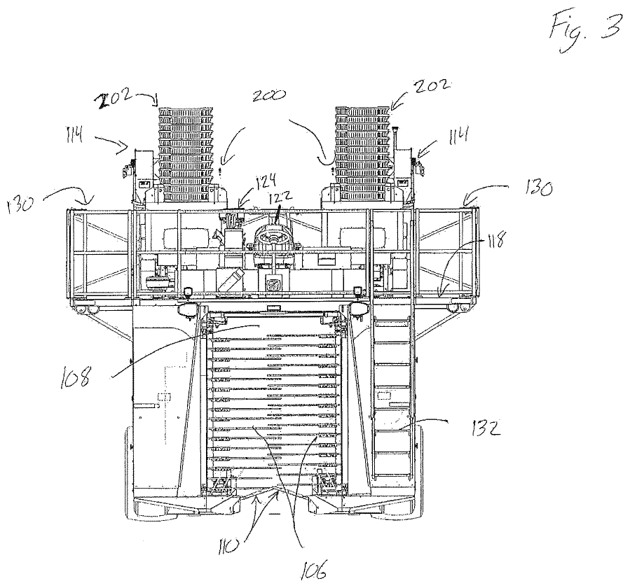

Referring now to the drawings, and in particular FIG. 1-3, there is shown an over the row berry harvester, generally designated (100). The harvester (100) includes a chassis (102) driving on wheels (104). Although in the embodiment shown the harvester (100) is a four wheel harvester, it can be appreciated that three wheel harvesters are also foreseen. A picking assembly (106) engages rows of plants that pass through a picking tunnel (108). The picking assembly (106) generally includes beaters, which may take on multiple configurations. Other plant engagement devices that dislodge fruit from the plants may also be utilized. A catching system (110) includes movable catch plates that collect the dislodged fruit, which rolls to a conveyor system. The conveyor system dumps the collected fruit onto a container filling and weighing system (150). A cleaning system (114) includes fans and may also include a manual inspection station at the container filling system to remove unwanted leaves, dirt and debris other than the fruit.

An operator sits in a driver's seat (122) to access the harvester controls (124). Workers inspect fruit and manage empty and filled containers on an operations platform (118). In some embodiments, sorter seats provide a place for inspecting fruit before being put into containers. The controls (124) may also operate the filling and weighing system (150). Railings (130) provide safety while ladders (132) provide access to the harvester for the operators.

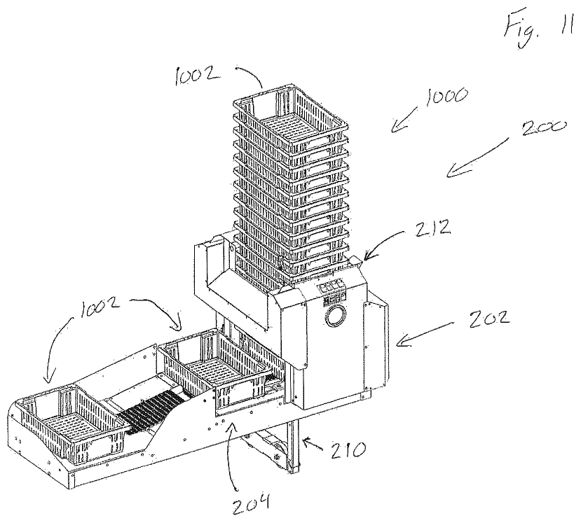

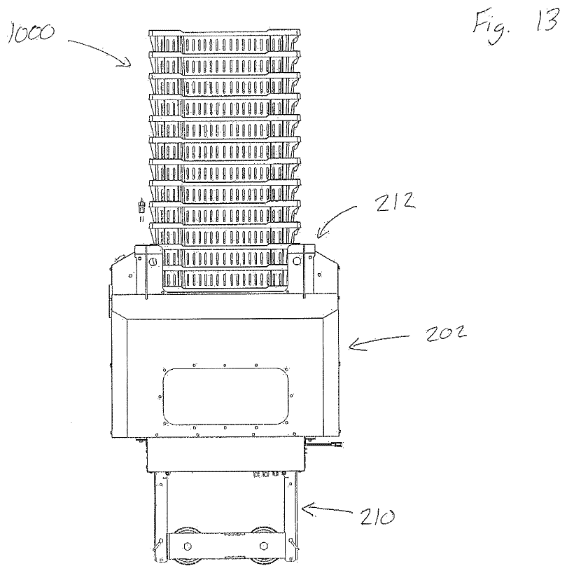

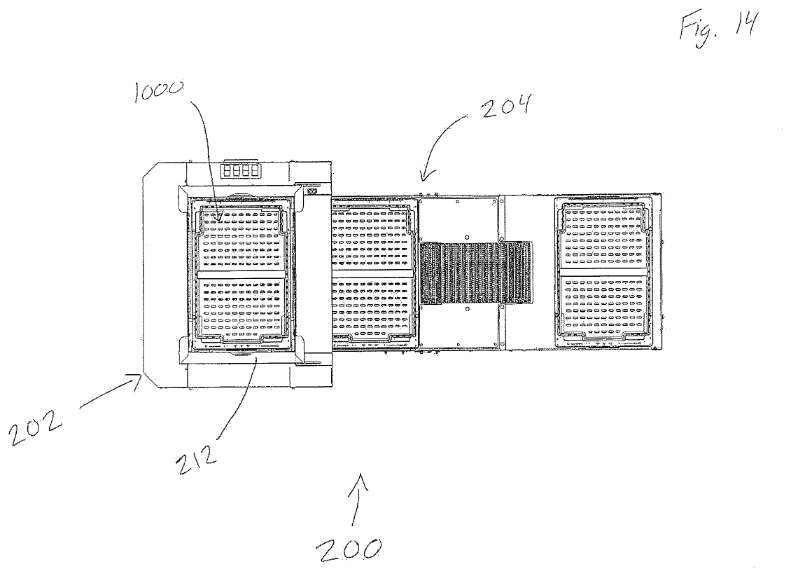

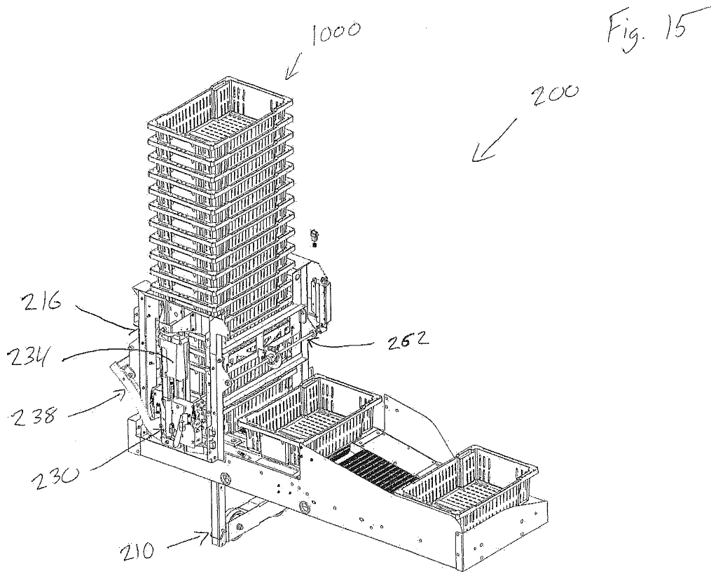

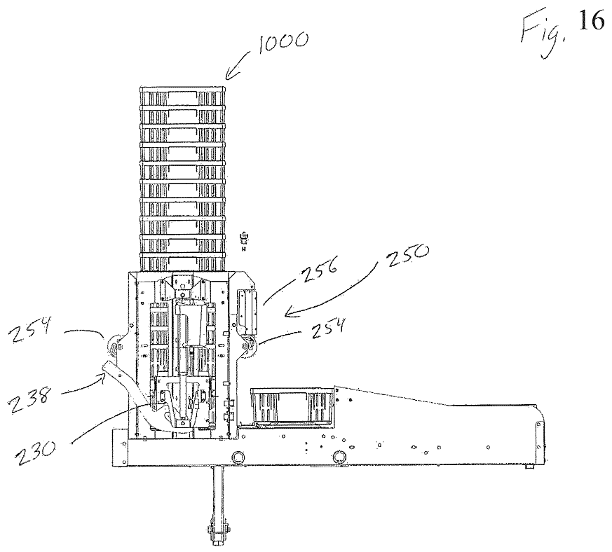

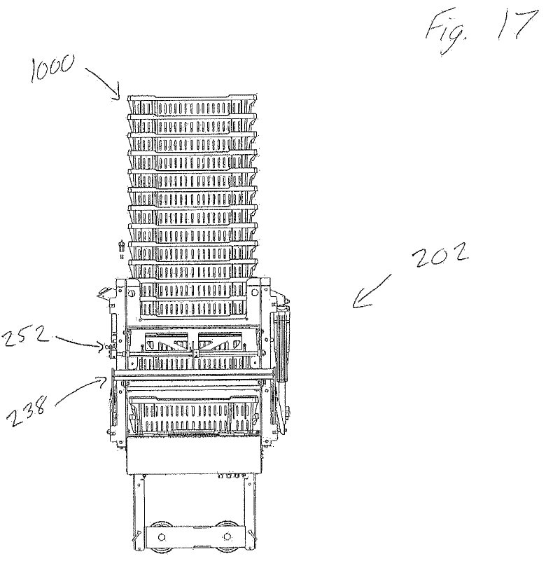

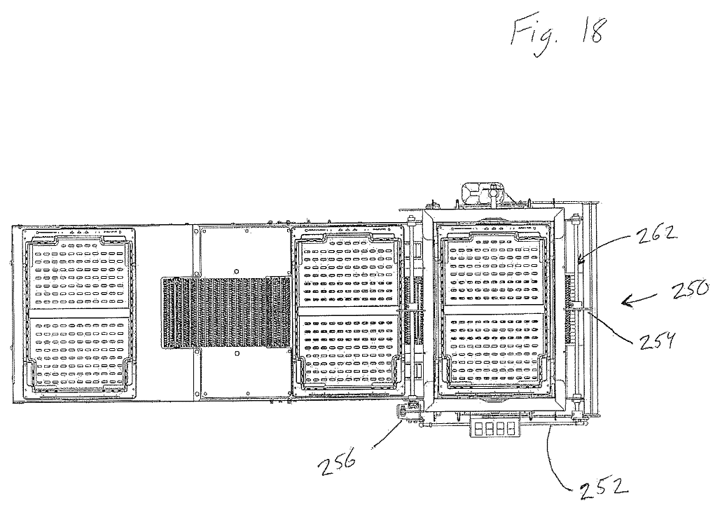

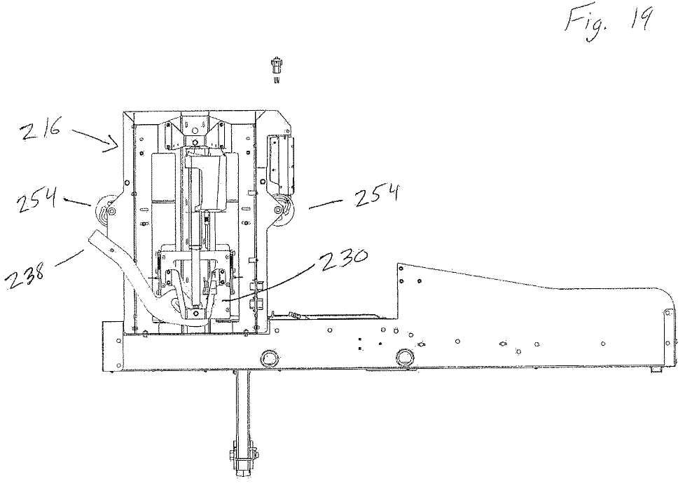

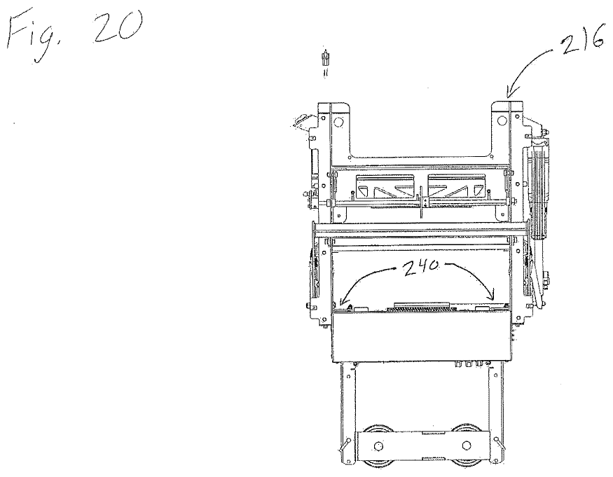

The harvester of the present invention moves filled berry containers out of the fruit stream and moves empty berry containers into the fruit stream on the harvester without direct operator input or contact. Racks may store empty containers at the rear of the harvester (100). Moreover, the operations platform (118) also provides a storage area for containers. Therefore, empty containers may be moved through the container filling system (150) and then stored when filled on the berry harvester (100) and removed at an end of the row or when the harvester is easily accessed. The filled containers are then transported to the fruit processing plant. Containers are managed and filled with three main sub-systems. A first sub-system is a container filling and weighing station (150) with a device for sensing the amount of berries in the container currently under the fruit stream of the filling and weighing station (150). A second sub-system is container transport assembly (204) for conveying containers (1002) to and through the fruit stream. A third sub-system is a container unstacking assembly (202) is for unstacking empty berry containers (1002) from a container stack (1000). The container unstacking assembly (202) and the container transport assembly (204) may be coupled together to form a container supply system (200), as shown in FIG. 11-20.

The harvester (100) can be configured to use diverse types of containers. A first type of container (1002) known as a “lug” is commonly used with blueberries, has a capacity of 15-25 pounds, and is generally shown in the Figures. Another smaller conventional type of container, known as a “flat,” has a capacity of 3-15 pounds. Either of these types of containers may be used with the harvester (100) of the present invention with proper dimensioning of the handling systems.

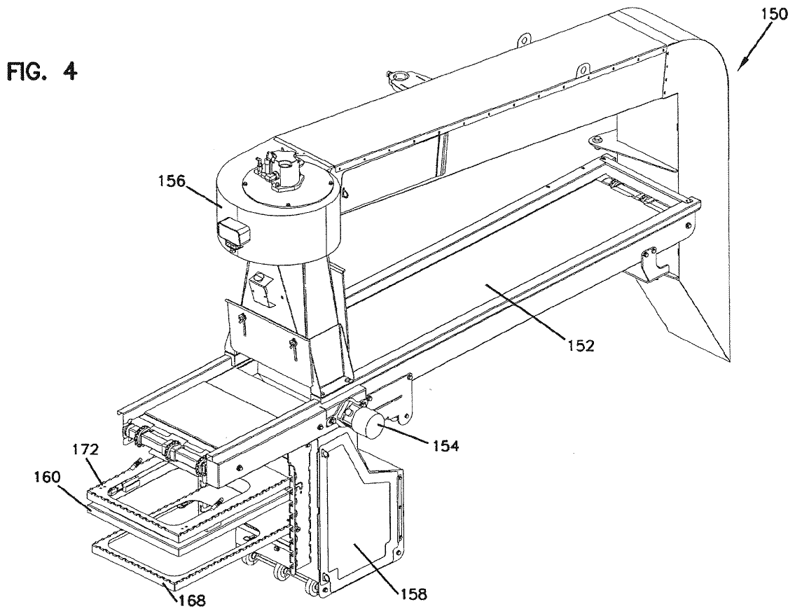

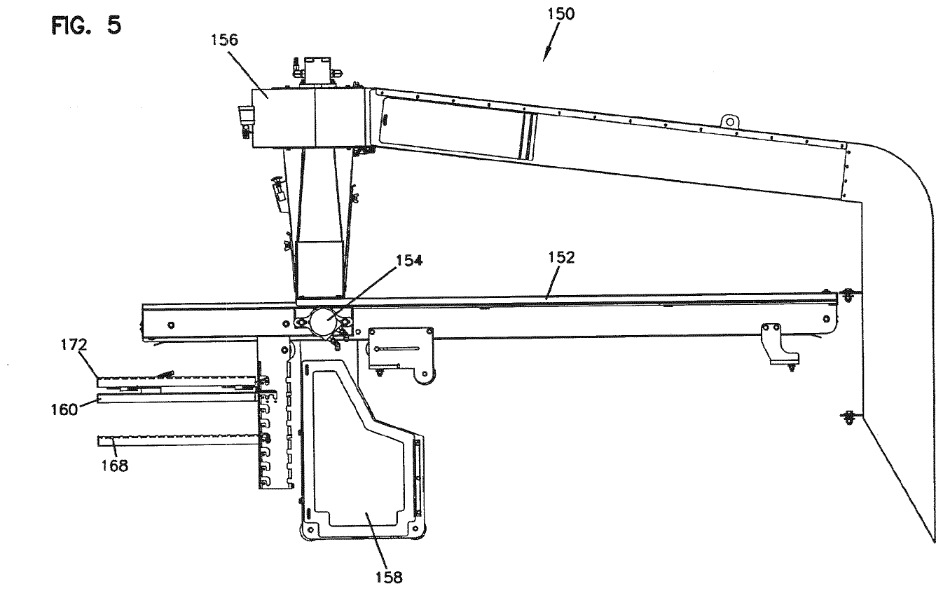

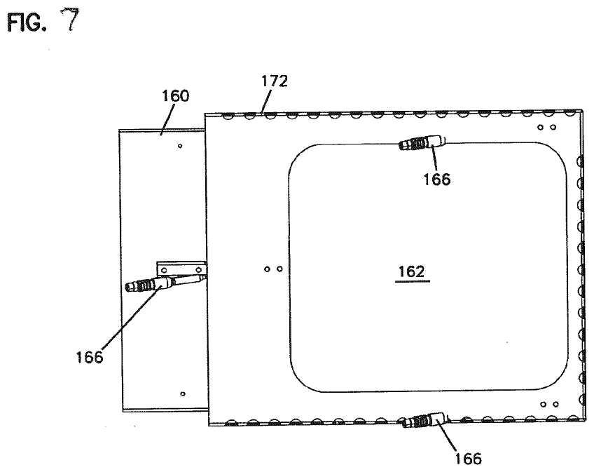

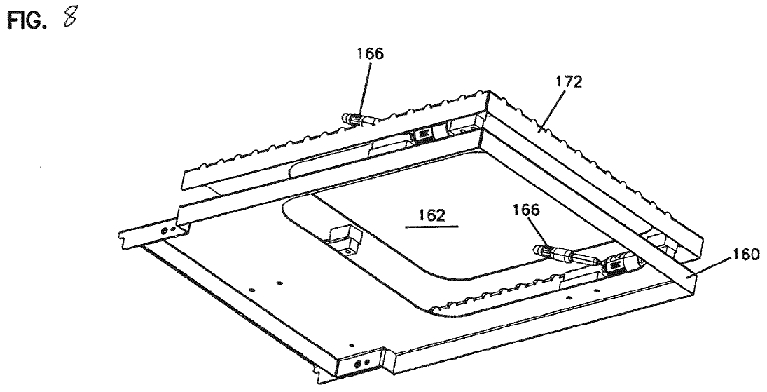

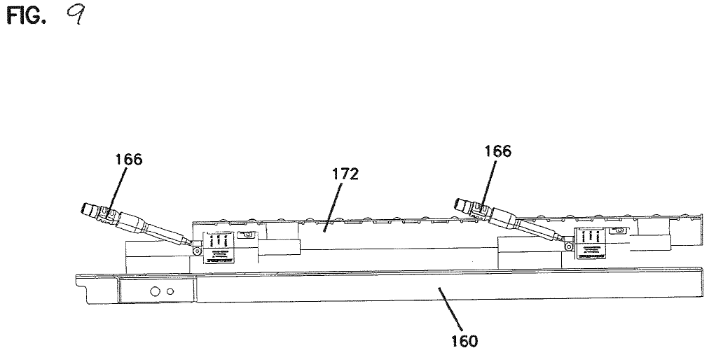

Referring now to FIGS. 4 and 5, after the berries have been delivered from the conveyor buckets, the berries are delivered to the container filling and weighing system (150). Such a system is disclosed in U.S. Pat. No. 10,834,873 to Korthuis, entitle BERRY HARVESTER WEIGHING SYSTEM, and assigned to Oxbo International Corp., the contents of which are incorporated herein by reference. In one embodiment, the container filling and weighing system (150) includes a fruit conveyor (152) driven by a motor (154). A container pan (160) is configured to support a weighing deck (172), which receives containers that receive fruit as it falls off the end of the conveyor (152). A final blower (158) delivers air to remove matter other than fruit. The final blower (158) may be used in conjunction with a suction fan (156). Together, the fans (156, 158) clean debris from the fruit. The belt of conveyor (152) is typically a mesh type element or formed of connected elements that allow for air to flow through the conveyor to achieve a cleaner harvested crop. As also shown in FIG. 5-9, the berries fall off the conveyor (152) into the containers, shown as lugs (1002), which are supported on a support pan (160). The pan (160) may have a large center opening (162) that allows for berries to fall to another container supported on a lower pan (168). In this manner, even when the upper containers (1002) are being switched, the conveyor (152) continues to operate and deliver berries to a container supported on the lower pan (168), thereby ensuring that all harvested crop is delivered to a container (1002). As explained hereinafter, a container (1002) is automatically moved from one side of the container fill system (150) when full. The next empty container is delivered adjacent and immediately behind the full container (1002). The container delivering fruit is paused so that fruit falls within the containers (1002). In some embodiments, sorters sit in seats and provide manual inspection of the fruit as well as manual removal of debris, such as twigs or other matter not removed by the air flow.

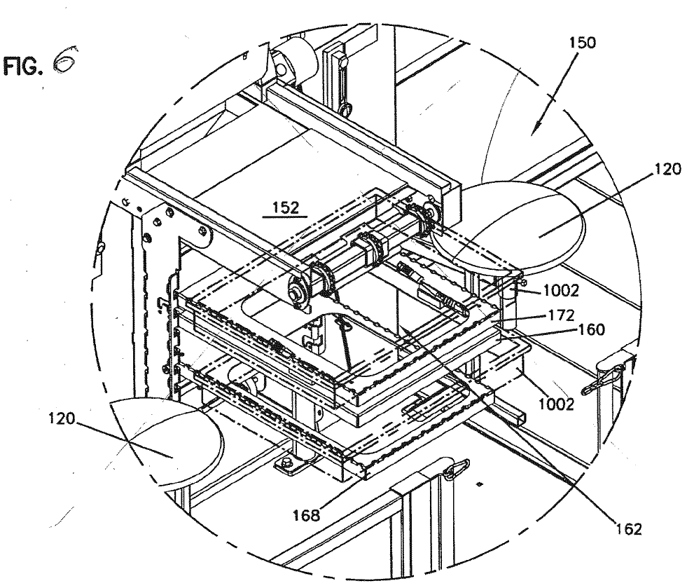

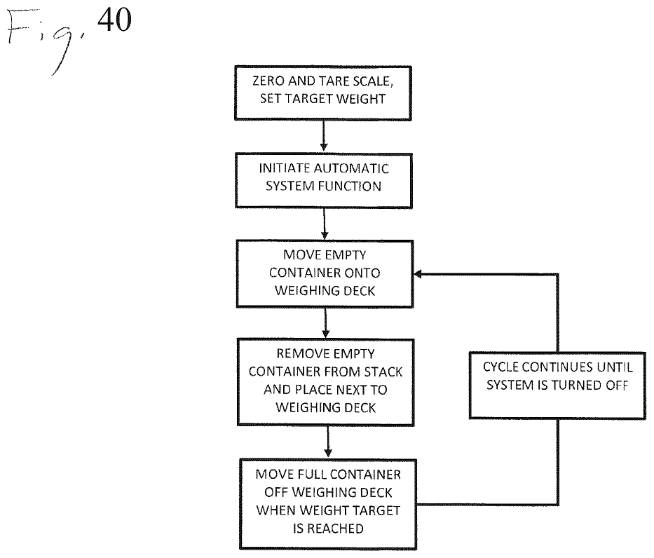

Referring to FIGS. 6-10, the container fill and weighing station (150) also includes load cells (166) engaging a weighing deck (172), which may have a center opening. The load cells (166) are actuated by the containers being placed on the weighing deck (172). As shown in FIG. 39, a processor (180) provides for taking the weight of the container into account and using a tare equal to the container weight. The processor (180) and/or the controls (124) preferably include a display (184) and/or an alarm (182). It can be appreciated that the fill and weighing system (150) is automatically set to weigh the crop in a container (1002). The processor is in communication with the display (184) to receive various parameters including the weight of the fruit in the currently filling container, total weight harvested and weight of harvested fruit since the last full containers were removed. The harvester (100) may include a global positioning system (186), such as a DataStar Crop Analyst system, to track and map crop data. The alarm (182) may be configured as a light and/or an audible alarm or bell. The processor (180) also incorporates an isolation system that eliminates vibrations from machinery and therefore ensures that there are no false readings and the actual weight of the berries in a container is accurate. The filling and weighing system (150) also utilizes the load cells (166) in order to ensure that the weighing system automatically resets when a filled container is removed from the weighing deck (172). The processor (180) provides for inputting different variables depending on the container being used and the desired load. The tare may also be adjusted to match the weight of the container being utilized. Moreover, different processing facilities may request different loads in each container so that the particular load may also be predetermined and selected to match the desired loads of the particular fruit being harvested.

The container filling and weighing station (150), container unstacking assembly (202), and the container transport assembly (204) are in communication with the processor (180), shown in FIG. 39, that controls and coordinates their operation and allows operator input for start/stop, calibration, and other functions. Together the systems (150, 202, 204) of the present invention eliminate a tedious manual operation and allow a farmer to standardize the weight of full berry containers across their entire operation.

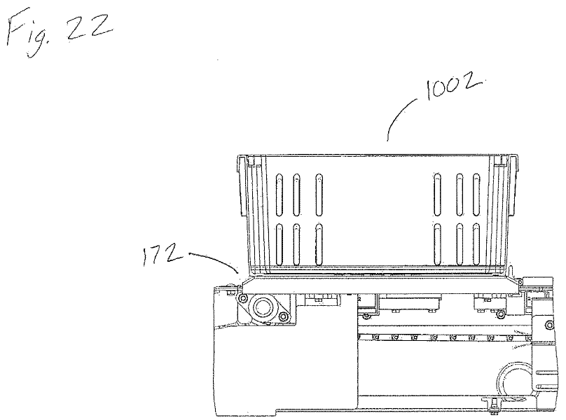

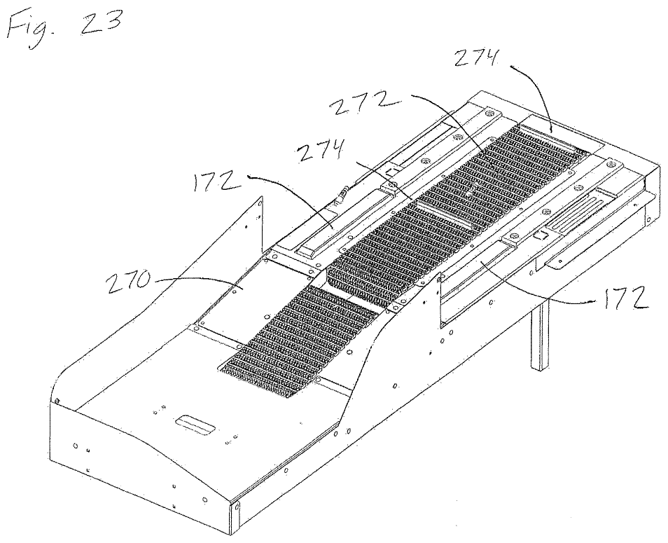

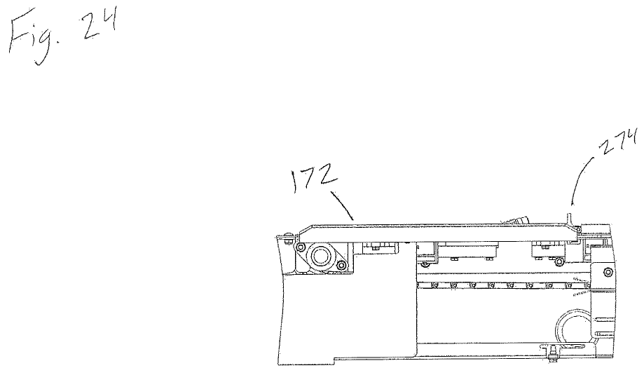

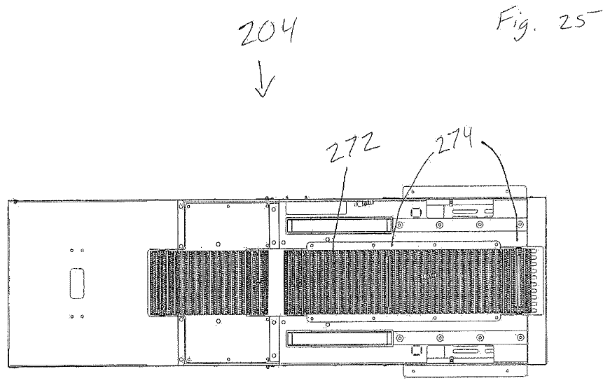

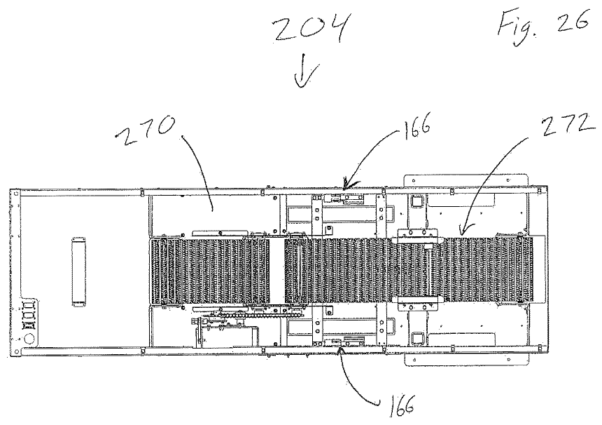

Referring to FIG. 11-36, the container supply system (200) includes the container unstacking assembly (202) and the container transport assembly (204). The container unstacking assembly (202) includes a base and a housing (212). A tower (216) is formed by the housing and extends vertically from the base. The tower (216) defines a vertical shaft in which a container stack (1000) of individual containers (1002) is retained.

According to the present invention, the containers (1002) are managed during normal operations in a continuous cycle, starting with an empty container (1002) positioned under the fruit stream coming off the conveyor (152). Once the container (1002) has reached the targeted fill level, the container transport assembly (204) automatically moves the full container out of the fruit stream onto a discharge table, belt, or other part of the harvester (100). The container transport assembly (204) also moves an adjacent empty container under the fruit stream.

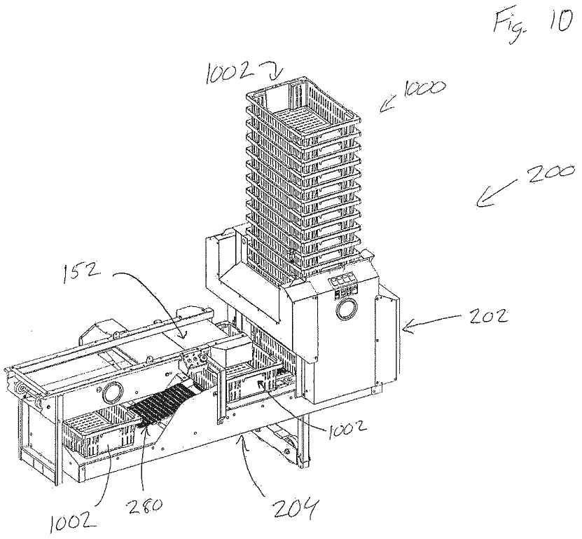

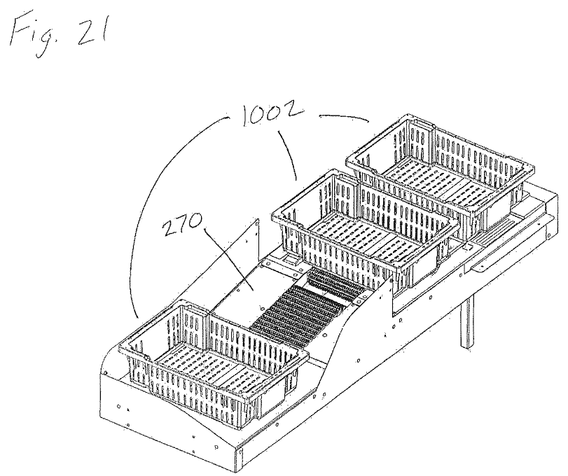

In a first embodiment of the container transport assembly (204) shown in FIGS. 21-26, the containers (1002) are slid on the surface of a base (270) moved together by an electric motor driving a conveyor belt (272) including flights (274) attached to the chain (272). In the embodiment shown, the base (270) is configured with two parallel spaced apart sliding surfaces with the drive system including the belt (272), located between the two portions of the base (270). It is appreciated that this movement could also be accomplished with a hydraulic motor, hydraulic cylinder, linear electric actuator, or a pneumatic actuator. The flight (274) move with the belt (272) and are spaced apart so that each flight (274) pushes one container (1002). The container transport assembly (204) with the paddles (274) spaced apart maintains containers (1002) at the proper spacing. Spacing of the flights (274) may be tailored to accommodate a particular style or size container (1002). In one embodiment, as shown in FIG. 10, after being filled, the containers (1002) are pushed onto a discharge conveyor (280) ready to be gathered with other filled containers (1002) for delivery to a processing plant. The operation of the container unstacking assembly (202) and the container transport assembly (204) is coordinated and automatically controlled by the processor (180) receiving information from the filling and weighing system (150). Therefore, containers (1002) are automatically delivered for filling, then accurately filled while being weighed until receiving the desired amount of fruit, and then delivered as full containers to an easily accessed position for delivery to a processing plant.

Once a container (1002) is filled with the prescribed amount of fruit, the container transport assembly (204) automatically advances all containers (1002) so that an empty container (1002) is moved into the filling position. Once a new empty container (1002) has been moved under the fruit stream, the container unstacking assembly (202) automatically removes another empty container (1002) from the bottom of a container stack (1000) and positions the container (1002) before a flight (274). While the present invention may include automatic positioning carried out with other configurations, such as by removing a container (1002) from the top of the stack (1000), feeding an empty container (1002) off a conveyor, or placing a container (1002) using a robotic arm, the configuration shown removing a container (1002) from the bottom of the stack (1000) has achieved reliable performance and requires only a small footprint on the harvester (100).

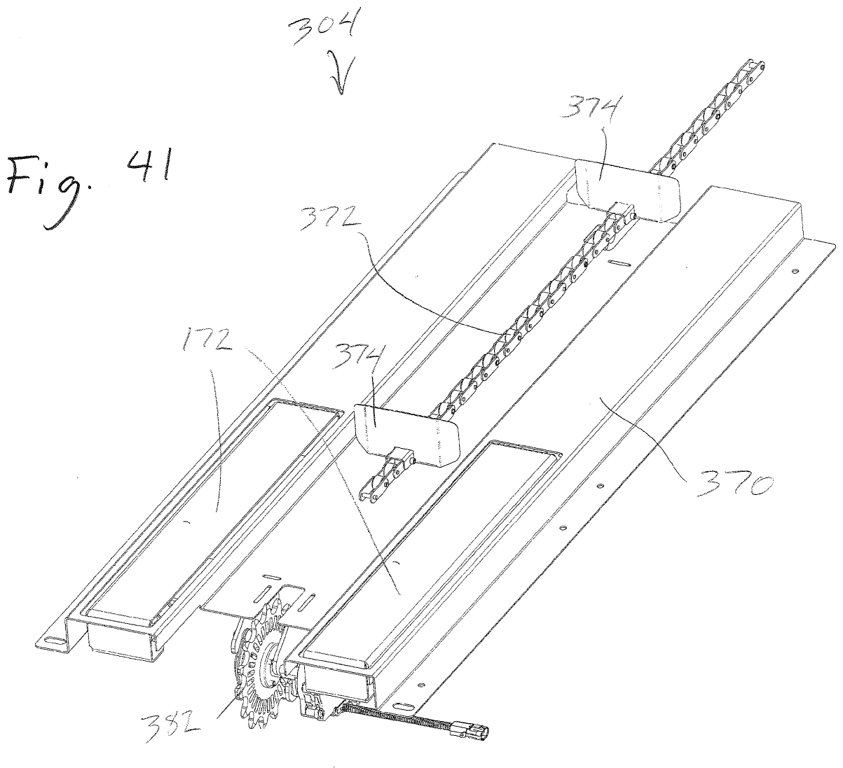

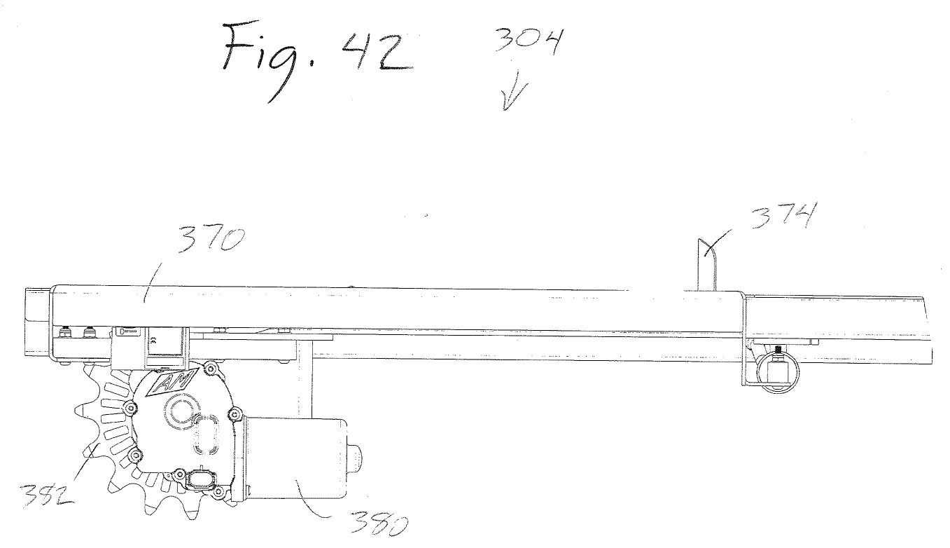

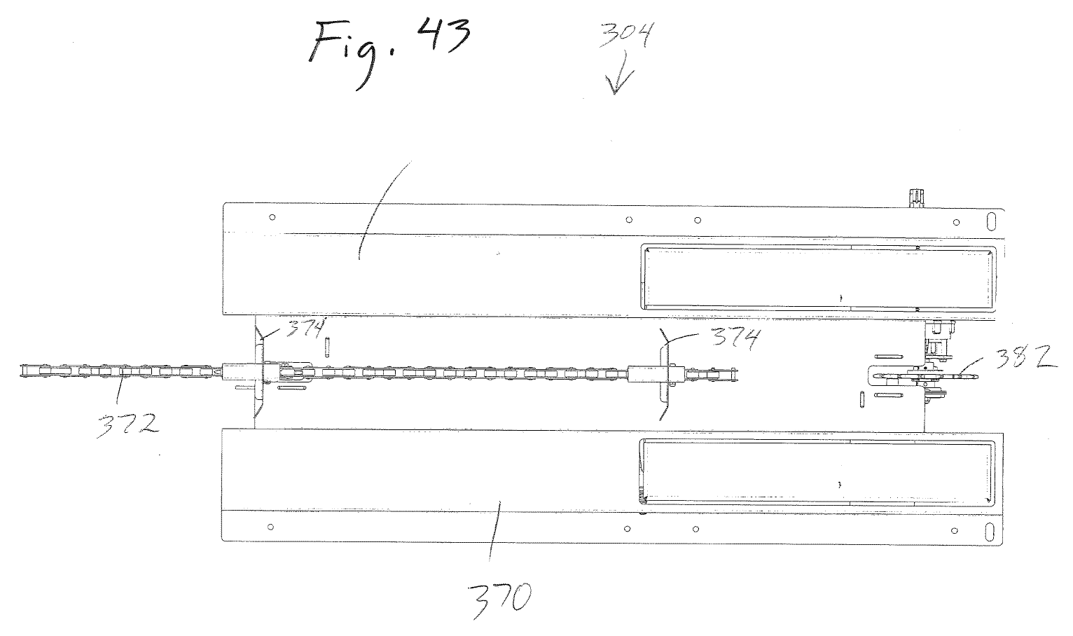

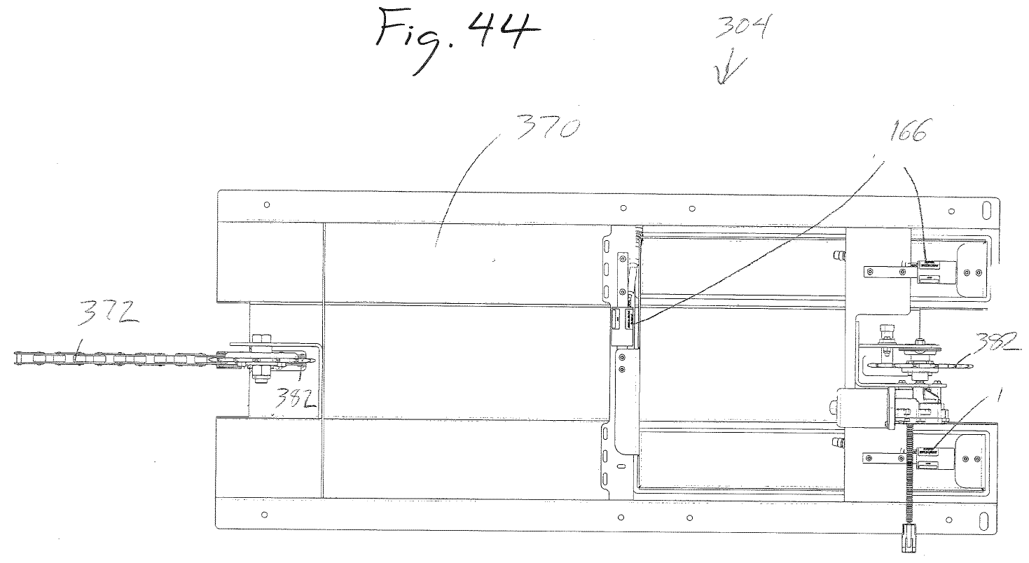

In a second embodiment of the container transport assembly (304) shown in FIGS. 41-44, the containers are slid on the surface of a base (370) moved together by an electric motor (380) driving a sprocket (382) engaging chain (372) with paddles (374) attached to the chain (372). The base (370) may be configured with two parallel spaced apart sliding surfaces with the drive system including the chain (372), located between the two portions of the base (370). It is appreciated that this movement could also be accomplished with a hydraulic motor, hydraulic cylinder, linear electric actuator, or a pneumatic actuator. The paddles (374) are pulled by the chain (372) and are spaced apart so that each paddle (374) pushes one container. The container transport assembly (304) with the paddles (374) spaced apart maintains containers at the proper spacing. Spacing of the paddles (374) may be tailored to accommodate a particular style or size container.

The container unstacking assembly (202) includes a base (210), and a housing (212) forming a tower structure (216) creating a rectangular vertical shaft receiving the container stack (1000). Two linear electric actuators drive the components. The tower is loaded with a stack (1000) of empty containers (1002) from the top, either manually by an operator or automatically using an additional automated mechanism. The first actuator moves a pair of supports (240) that together form an elevator carriage (232) that moves vertically within the tower. The second actuator operates a clamp to hold the stack of empty containers (1000) within the tower (216).

The container unstacking assembly (202) includes an elevator assembly including side supports (240) extending below the container stack (1000) to form a carriage (232) and support the bottommost container (1002). The opposed side supports (240) are joined by an exterior coupling arm (238) so that the carriage half formed by one of the side supports (240) moves with the carriage half formed by the other side support (240) in tandem to form the vertically movable carriage (232). The elevator assembly (230) includes a linear actuator (234) to provide up and down movement of the carriage (232) within the vertical shaft formed by the tower (216).

The container unstacking assembly (202) also includes an end engagement assembly (250) configured to engage ends of a container (1002) and support the container as well as any containers stacked above the end supported container (1002). In one embodiment, a clamp actuator (256) is connected to a linkage (252) with a cam (254) rotationally supported on a corresponding shaft (262) at each end of the tower (216). The clamp actuator (256) extends and retracts end support clamps or tabs (260) that are configured to extend and retract together through the linkage (252) to form a clamp when extended with one of the containers (1002) between the end support tabs (260). It is appreciated that the “sides” and “ends” are used only as points of reference and that the supports (240) and tabs (260) may have their positions interchanged. However, generally the tabs (260) should be on opposed sides and the supports (240) should be on the other opposed sides of the containers (1002). When in an extended position, the end support tabs (260) function as clamps to engage one of the containers (1002) below an upper lip (1004) of the container. When the end support tabs (260) are extended inwards at the ends of the container stack (1000), the entire container stack (1000) above the end support tabs (260) is supported on the end engagement assembly (250). When the end support tabs (260) are retracted and pulled away from one another, the end support tabs (260) are disengaged from any of the containers (1002) and the stack is supported on the carriage (232). The linear actuator and cam mechanism shown is just one example of an actuating mechanism, which could also be operated in a variety of other ways to extend and retract end support tabs (260) and to separate a bottommost container (1002) from the container stack (1000).

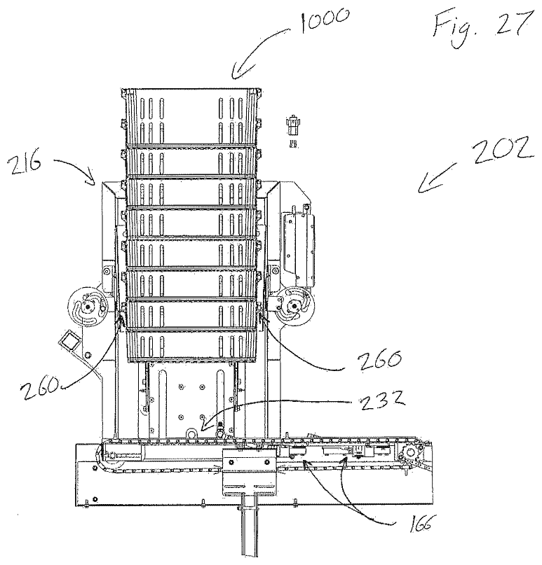

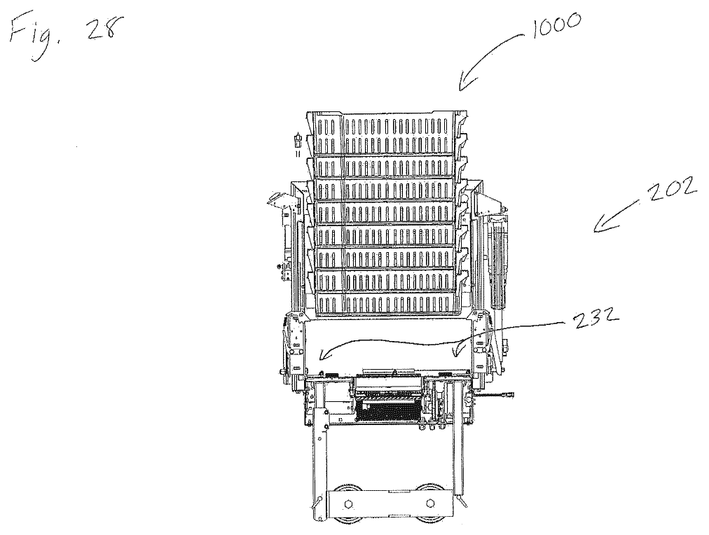

To remove a container from the stack, the container unstacking assembly (202) proceeds through the following steps. In a first operational position shown in FIGS. 27 and 28, the carriage (232) is completely lowered. A bottommost container has been separated and advanced by the container transport assembly (204). At this operational position, the end support tabs (260) are extended toward one another and the container stack (1000) is supported by the end engagement assembly (250).

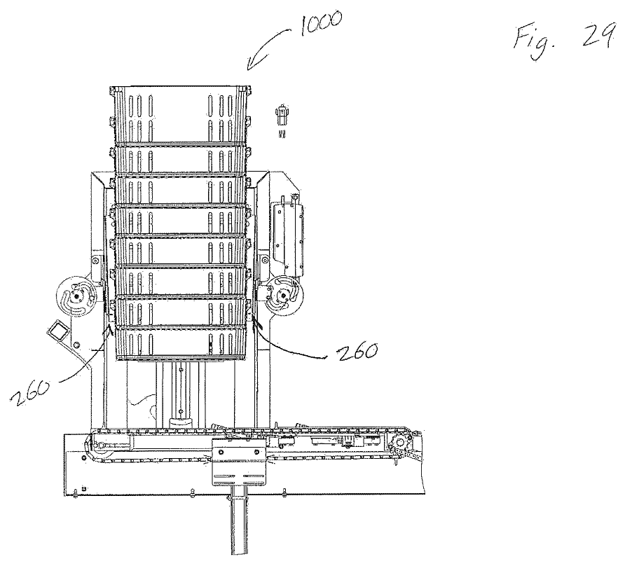

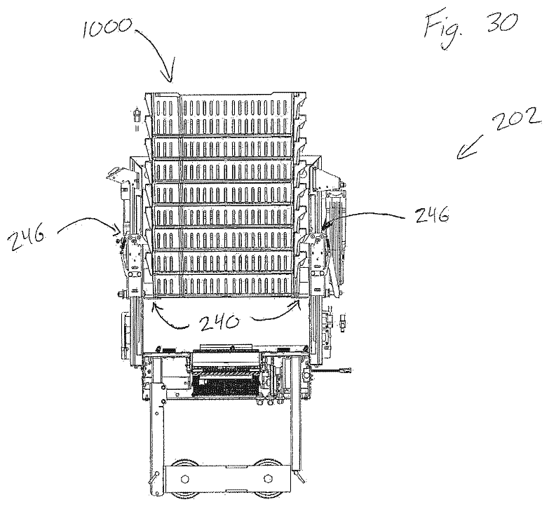

To remove the bottommost container (1002) from the container stack (1000), the carriage actuator (234) retracts, moving the carriage (232) up and lifting the entire stack (1000) of empty containers (1002) off the end support tabs (260). Both halves of the carriage (232) are raised simultaneously by using a connecting arm (238) pivoting at the side of the tower (216). The connecting arm (238) transfers the motion of the carriage actuator (234) to the far side of the tower and keeps the carriage halves (240) on opposite sides of the container stack (1000) aligned and moving together. The carriage (232) is raised until engaging the bottommost container and the entire container stack (1000) is lifted in a second operational position, as shown in FIGS. 29 and 30.

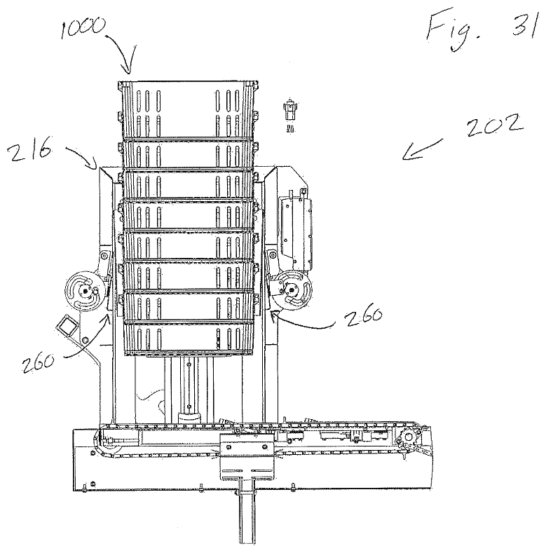

From the second operational position, the clamp actuator (256) rotates the cams (254), retracting the tabs (260) on both ends of the container stack (1000). The clamp actuator (256) is connected to the linkage (252), which coordinates extension and retraction of the clamp halves formed by the end support tabs (260) on each end of the tower (216). At this third operational position shown in FIG. 31, the carriage (232) is raised as in the second operational position and the end support tabs (260) are retracted.

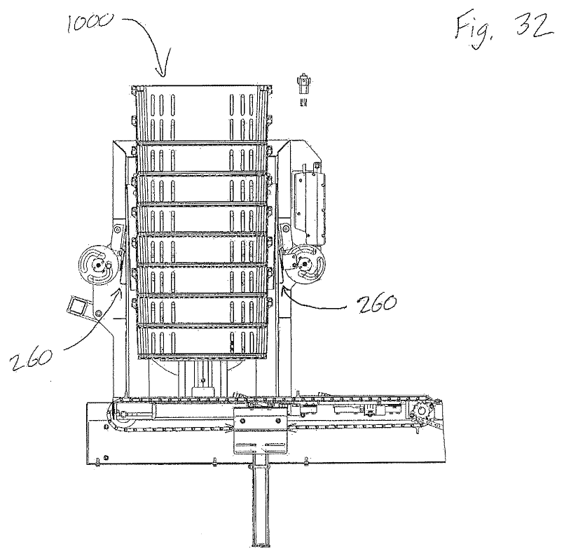

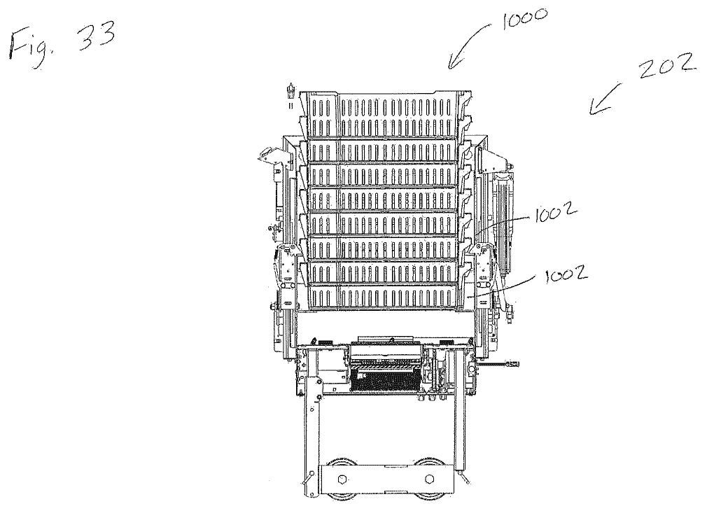

The carriage (232) is then moved down by an amount equal to the spacing of one container (1002) in the stack (1000). At this fourth operational position shown in FIG. 32-33, the carriage (232) is raised, but at a position lower than at the second and third operational positions, and with the stack (1000) lowered so the bottommost container (1002), including the upper lip (1004), is below the end support tabs (260), which are still retracted.

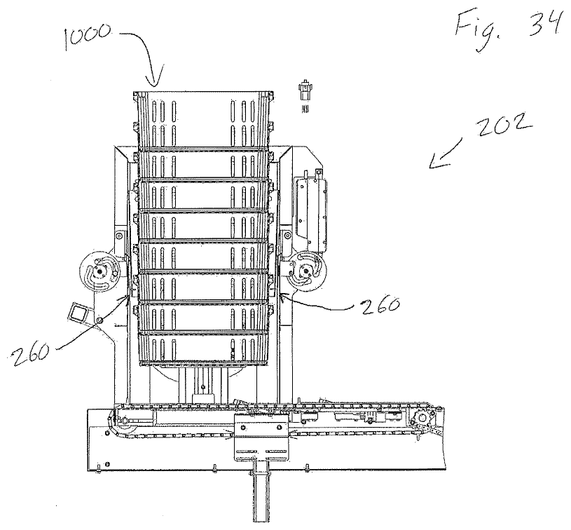

While the carriage (232) is at this height with only the bottommost container (1002) below the end support tabs, the end support tabs (260) are extended inwards toward one another and function as a clamp to support the container stack (1000), except for the bottommost container (1002), which is now below the end support tabs (260). At this fifth operational position shown in FIG. 34, the carriage (232) is at the same height as in the fourth operational position, and the end support tabs (260) are extended so that the next to bottommost container is supported by the end support tabs (260), while the bottommost container is separated from the stack and separately supported on the carriage (232).

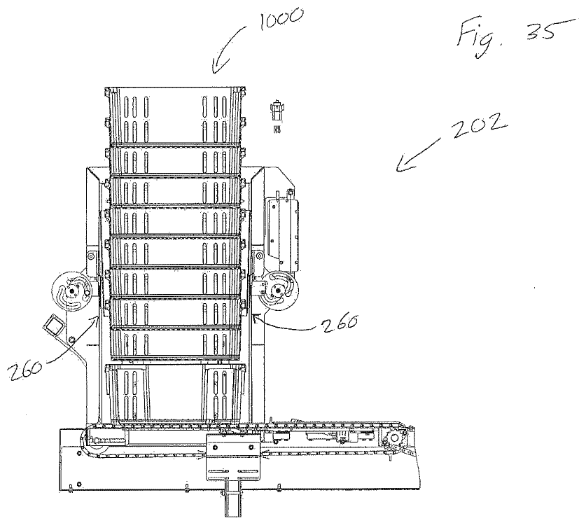

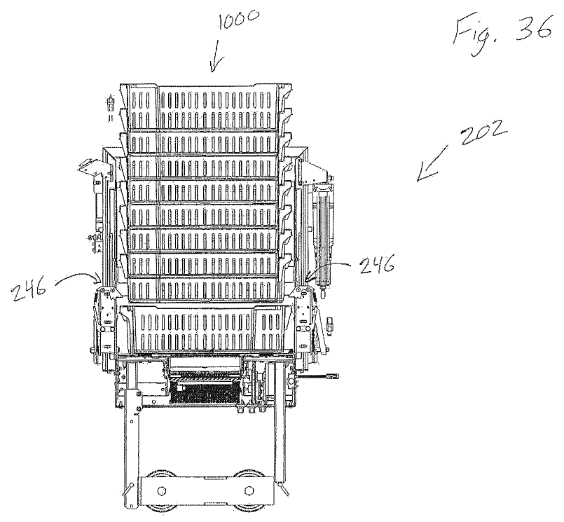

Finally, the carriage (232) moves downward, and the separated bottommost container (1002) is lowered away from the rest of the stack (1000). At a sixth operational position shown in FIG. 35-36, the carriage (232) supports the separated container (1002) at a fully lowered position and the remaining containers are supported by the end support tabs (260). At this operational position, the bottom container (1002) pulled from the stack (1000) has been positioned next to the container currently being filled (in an “on deck” position), and the entire process can be repeated.

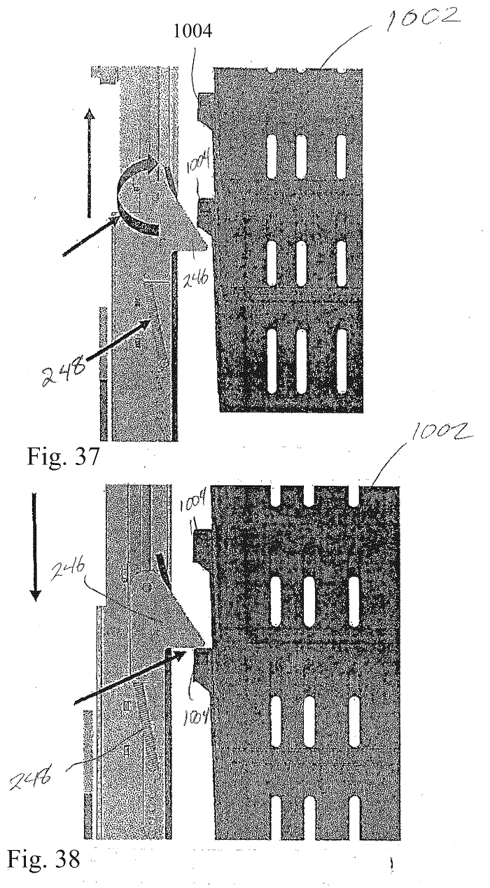

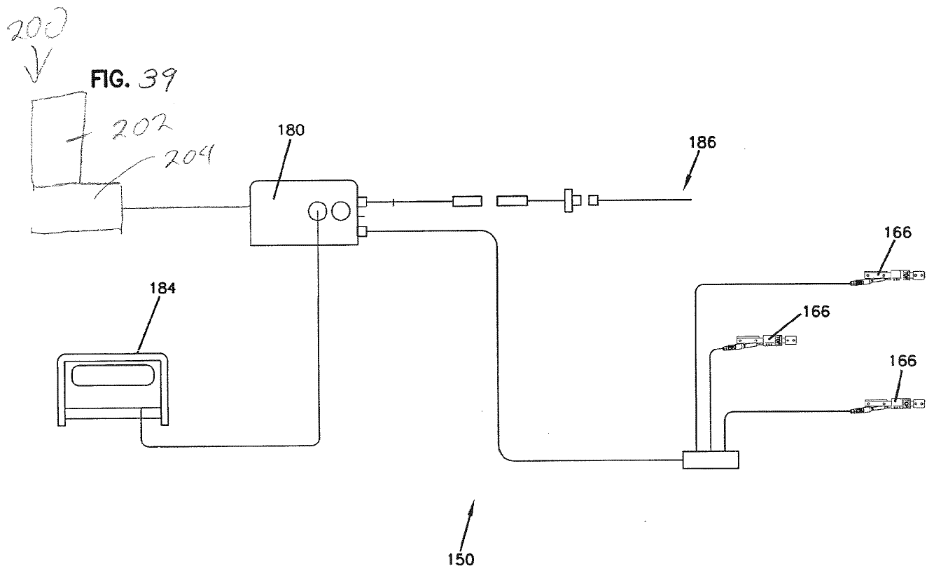

The carriage (232) may include spring loaded tabs (246), such as shown in FIGS. 30 and 36, that slide past the edges of the containers (1002) while the carriage (232) is moving upward, but cannot move past the edge of the containers (1002) while the carriage (232) is moving downward. In one embodiment, as shown in FIGS. 37 and 38, the tabs (246) are configured with a sloped upper engagement surface and a substantially horizontal lower engagement surface. The tabs (246) are rotatably mounted and biased by a spring (248). When moving upward the sloped upper engagement surface engages an underside of a lip (1004) of the containers (1002) and is pivoted outward, allowing the tab (246) to move upward past the bottommost container (1002). The spring (248) biases the tab (246) back to a home position with the lower engagement surface of the underside of the tab (246) being substantially horizontal. The lower engagement surface therefore engages the top of the lip (1004) of the bottommost container (1002). The extended tab (246) allows the downward motion of the carriage (232) to pull the lowest container (1002) from the bottom of the stack (1000). As the carriage moves downward, the separated container (1002) is taken down to the starting, lowest position. Such spring loaded tabs (246) may be used to eliminate a cam system and linkage for extending and retracting tabs in some embodiments.

The embodiment of the carriage (232) with the spring loaded tabs (246) is operated in a manner similar to the embodiment with retractable/extendible tabs. To remove a container (1002) from the bottom of the stack (1000), the carriage (232) is raised to a position at which the tip of the tabs (246) engages the lip (1004) of the bottommost container (1002) and is pushed away from the lip (1004) and then continues until the tabs (246) are above the lip (1004) of the bottommost container (1002). At this height, the springs (248) pull the corresponding tabs (246) to the extended position above the lip (1004) of the bottommost container (1002). The carriage (232) is then moved downward, and the lower surface of the tabs (246) is above the top of the lip (1004) of the bottommost container (1002) and support the next to bottommost container (1002). The tabs (246) are therefore between the bottommost container and the next to bottommost container so that the bottommost container is separated from the stack (1000). The carriage (232) is then fully lowered, and the separated container (1002) is placed in the container delivery system (204).

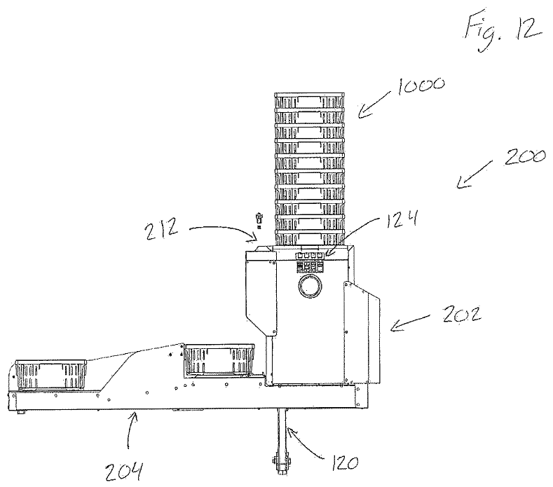

In operation, the weighing system (150) is set up as shown in FIG. 12. The weight of the containers may be stored in the processor as a tare, allowing only the weight of the fruit in the container to be measured. Moreover, the desired weight is input so that the alarms will signal when the preselected weight is reached and the transport assembly (204) and destacking assembly (202) automatically deliver another container (1002). In some embodiments, the type of alarm and readouts may also be programmed. When the weighing system has been set, the harvester (100) may proceed with harvesting along plant rows with the fruit plants passing through the picking tunnel (108). The picking assembly (106) engages the plants and dislodges fruit. The fruit falls onto the catching system (110), where the fruit is directed to the conveyor assembly (112). Material other than fruit is separated by the cleaning system (114). The conveyors (112) deliver the fruit to the fill and weighing system (150) where the fans (156, 158) provide final separation. Workers may also inspect the fruit to remove fruit that is not acceptable and/or other debris and to also remove bruised, unripe or other unsuitable fruit. The destacking assembly (202) and the container transport assembly (204) automatically provide an empty container (1002) on the weighing deck (172). Fruit is delivered until the preselected amount of fruit is received into the container (1002). The system (150) then provides an alarm and/or readout to the operators that the container is filled to the desired weight and the transport assembly (204) moves the filled container and slides a second empty container into the space for filling on the weighing deck (172). The filled container (1002) is pushed along the discharge conveyor (280) and then stored on the deck (118) until the end of the row is reached or a convenient point for unloading the filled containers is reached.

The processor (180) is able to filter out the vibration imparted from the over the row harvester (100) and provide an accurate reading. Once the desired weight is achieved, the processor (180) automatically resets the system (150) for a new empty container. The process is repeated until the system (150) is shut off. It can be appreciated that interruptions including lengthy pauses do not affect the filling and weighing system (150), the container transport assembly (204) or the container destacking assembly (202). Moreover, if conditions or requirements changes, the container filling system (150) may be reset with different inputs to reflect the requirements.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A fruit harvester, comprising:
a chassis;
a fruit removal system;
a fruit delivery system;
a container delivery system for automatically separating an individual container from a stack of containers;
a container filling station receiving fruit from the fruit delivery system and individual separated containers from the container delivery system and filling the containers with a predetermined amount of fruit.

2. The harvester according to claim 1, the container delivery system comprising:
a support framework defining a vertical open shaft configured for supporting a stack of containers;
an elevator with support brackets extending below the stack of containers;
retractable tabs configured for engaging the containers when in an extended position; and
an actuator for extending and retracting the tabs.

3. The harvester according to claim 2, wherein the actuator comprises spring loaded tab and complementary engagement surfaces on the tabs and container.

4. The harvester according to claim 2, wherein the actuator comprises a linkage.

5. The harvester according to claim 4, wherein the linkage comprises a cam assembly.

6. The harvester according to claim 2, wherein the support brackets extend in a first direction and the retractable tabs extend in a second direction transverse to the first direction.

7. The harvester according to claim 1, wherein the container filling station comprises:
a fruit delivery apparatus;
a container support;
a container weighing system generating a weighing signal;
a processor in communication with the weighing system, the processor cancelling vibrations from the weighing signal.

8. The harvester according to claim 1, comprising a control system automatically controlling and coordinating the container delivery system and the container filling station.

9. The harvester according to claim 1, further comprising a processor, wherein the processor is in communication with a position indicator, the processor being configured to map yields.

10. A fruit harvester comprising:
a destacking assembly for removing a container from a stack of containers;
a filling station for filling a removed container with a predetermined amount of fruit;
a weighing assembly for sensing when the predetermined amount of fruit has been reached for each container;
a container transport assembly for delivering an empty container into a filling station, and automatically moving a filled container out of the filling station when the weighing assembly senses that the predetermined amount of fruit has been reached.

11. The harvester according to claim 10, comprising a control system automatically controlling and coordinating the container destacking assembly, the container transport assembly, and the filling station.

12. The harvester according to claim 11, wherein the control system comprises a processor, wherein the processor is in communication with a position indicator, the processor being configured to map yields.

13. The harvester according to claim 11, wherein the control system comprises a processor, the processor cancelling vibrations from the weighing signal.

14. The harvester according to claim 10, wherein the destacking assembly is configured to remove a container from a bottom of the stack of containers.

15. The harvester according to claim 10, wherein the container transport assembly is configured to move a next container to the filling station.

16. The harvester according to claim 10, wherein the container transport assembly comprises a belt with spaced apart flights.

17. The harvester according to claim 10, wherein the container transport assembly comprises a chain pulling spaced apart paddles, each paddle being configured and spaced apart to engage one container.

18. A fruit container delivery system comprising:
a support framework defining a vertical open shaft configured for supporting a stack of containers;
an elevator with support brackets extending below the stack of containers;
retractable tabs configured for engaging edges of the containers in an extended position, and an actuator for extending and retracting the tabs.

19. The container delivery system according to claim 18, wherein the actuator comprises a linkage.

20. The container delivery system according to claim 19, wherein the linkage comprises a cam assembly.

21. The container delivery system according to claim 18, wherein the support brackets extend in a first direction and the retractable tabs extend in a second direction transverse to the first direction.

22. A container delivery system according to claim 18, the container delivery system being configurable at:
a first position without a separated container, the carriage lowered, and with the tabs extended and supporting the container stack;
a second position with the carriage raised and with the stack lifted off of the tabs;
a third position wherein the carriage remains raised, and the tabs are retracted;
a fourth position wherein the stack is lowered so a bottommost container is below the tabs;
a fifth position wherein the tabs are extended and a next to bottommost container is supported on the tabs and the bottommost container is separated from the stack;
a sixth position wherein the carriage supporting the separated container is fully lowered.

23. A container removal system configured for installation on a harvester, comprising:
a support framework defining a vertical open shaft configured for supporting a stack of containers;
an elevator with opposed support brackets extending below the stack of containers;
retractable tabs configured for engaging the containers in an extended position, and an actuator for extending and retracting the tabs, the tabs being configured to extend and retract on sides of containers transverse to sides engaged by the support brackets.

24. A method of harvesting and filling containers with fruit with a harvester having a container filling station and a container delivery system, the method comprising:
removing fruit from plants;
automatically delivering the fruit to the container filling station;
automatically removing a fruit container from of a stack of fruit containers, delivering the removed fruit container to the fruit filling station; and
automatically filling the fruit containers with a predetermined amount of the fruit.

25. The method according to claim 24, comprising automatically removing the fruit container from a bottom of the stack of fruit containers.

26. The method of claim 24, wherein separating the fruit container from the stack comprises using a carriage for supporting a bottom of the fruit containers and extendable and retractable tabs engaging opposed portions of the fruit containers, the method comprising:
configuring the carriage to a first position without a separated fruit container and the carriage is lowered and the tabs are extended and supporting the stack of fruit containers;
configuring the carriage to a second position wherein the carriage is raised and the stack is lifted off the tabs;
configuring the carriage to a third position wherein the carriage remains raised, and the tabs are retracted;
configuring the carriage to a fourth position wherein the stack is lowered so a bottommost fruit container is below the tabs;
configuring the carriage to a fifth position wherein the tabs are extended and a next to bottommost fruit container is supported on the tabs and the bottommost container is separated from the stack; and
configuring the carriage to a sixth position wherein the carriage is supporting the separated container and the carriage fully lowered.

27. A container removal apparatus, for removing a bottommost container from a stack of containers, the apparatus comprising:
a stack enclosure forming a vertical passage for receiving a stack of containers;
a lift assembly for lifting the stack of containers;
a separator assembly for removing a bottommost container from the stack of containers;
a transport assembly delivering the removed bottommost container from the container removal apparatus.
